(19) United States
(12) Patent Application Publication
(10) Pub. No.: US 2009/0307215 A1
(43) Pub. Date: Dec. 10, 2009

(54) NETWORK RESOURCE ANNOTATION AND SEARCH SYSTEM

(75) Inventors: Derek BALL, Calgary (CA); Dayton FOSTER, Calgary (CA); James SEIGEL, Calgary (CA)

Correspondence Address: KENYON & KENYON LLP, RIVERPARK TOWERS, SUITE 600, 333 W. SAN CARLOS ST., SAN JOSE, CA, 95110, US

(73) Assignee: TYNT MULTIMEDIA, INC., Calgary (CA)

(21) Appl. No.: 12/478,668

(22) Filed: Jun. 4, 2009

Related U.S. Application Data
(60) Provisional application No. 61/129,097, filed on Jun. 4, 2008.

(51) Int. Cl. G06F 17/30; G06F 15/173

(52) U.S. Cl. 707/5; 707/10; 709/223; 707/E17.014; 707/E17.032; 707/3

(57) ABSTRACT

A method and system for annotation of network resources existing within an electronic network. Further provided for is a method for increasing, or decreasing the relevance of network resources forming part of a search result of a network through use of annotations associated with network resources.

### RELATED APPLICATION

The present application claims the benefit of U.S. Provisional application, Ser. No. 61/129,097 filed Jun. 4, 2008, entitled “NETWORK RESOURCE ANNOTATION AND SEARCH SYSTEM.” The disclosure of this application is incorporated herein by reference in its entirety.

### FIELD OF THE INVENTION

The present invention pertains to the field of searching for, and presentation of, resources within a network.

### BACKGROUND OF THE INVENTION

All of the publications, patents and patent applications cited within this application are herein incorporated by reference in their entirety to the same extent as if the disclosure of each individual publication, patent application or patent was specifically and individually indicated to be incorporated by reference in its entirety.

In recent years the popularity of computers, and the communication networks established between these computers, have increased dramatically. Such communication networks allow computer users to communicate with each other, either through a centralized communication point, a plurality of distributed and redundant communication points, or directly. This allows exchange of information between the computers on the communication network using a common communication protocol between them. It is common for corporations or businesses to establish a common network between their computers, otherwise referred to as “intranets,” in which the communication network provides limited or no access to unauthorized persons and/or computers. It is common for intranets to be protected by security systems, such as firewalls, which may prevent access by unauthorized users of the network, the computers communicating through it, and the information contained within these computers.

The term “Internet” has been adopted to describe the publicly available network which has nearly worldwide coverage, and to which most personal computers have access. The pervasive nature of the Internet, combined with the lower cost and increased performance of personal computers, has led to it being a popular source of information. Systems are available which provide an individual with the ability to search for information or resources within the Internet. By way of non-limiting example, systems exist which allow a user to search for information stored on other Internet computers (servers), thus providing generalized access to these resources. Unfortunately, when an individual is searching for specific information, the resource on the Internet may not provide the specific information desired by the individual, or else it may provide certain information in an undesired context. The individual may then continue searching, or else use an alternate system to perform the required searching activities. In general, these searching systems provide minimal ability for a user to provide feedback as to the success of the search, or ways for the user to refine future searches. Generally, the user establishes a series of search terms to initiate a search, and upon failure of the search results to provide the user with what he is looking for, the user modifies or adds further search terms in an effort to increase the chance of success on the next search. Alternatively, the user may switch to an alternate search system and attempt to obtain a successful search result using that second system.

Computers communicate within a network using a common set of standards for exchanging data. One common example is the Transmission Control Protocol/Internet Protocol (TCP/IP) suite. To initiate communications within the communication network, a user (client) may contact another computer on the network (server) and request information or a resource. This is facilitated by various software and hardware systems generally available. A user can access resources within the Internet by being directed through software (e.g., by clicking a hyperlink), by entering a Universal Resource Locator (URL), etc.

A popular protocol for organizing and sharing information on the Internet via the client/server model is known as the HyperText Transfer Protocol (HTTP), and is more commonly referred to in a general sense as the World Wide Web (the web). Generally, the web links information by associating items of interest through the use of HyperText Markup Language (HTML) files, which reside on servers and usually are transferred to clients via HTTP. A user of the web may traverse it by receiving and viewing an HTML file (or just an image, video, etc.), which may contain within it information or embedded images, but which also may contain information on how to acquire further resources from the web, by, for example, incorporating URLs within the file. This information may be displayed to a user as a combination of text and media (for example images, sound, video) and generally is referred to as a “page” or “web page.” Generally, the user uses a client, called a web browser, to interact with the web and the various files found on it (e.g., HTML, audio and video files, etc.).

No central authority exists for cataloguing the hundreds of millions of network resources, such as HTML pages, files or media available within an intranet or the Internet. In general though, there are two approaches taken for finding information or resources of interest within a network: 1) a directory hierarchy and 2) a search engine.

Within a directory hierarchy a web page may be analyzed and categorized, allowing users to scan through various categories, and associated subcategories, to identify resources of interest. Alternatively, a search engine may provide a dataset of terms and phrases (keywords) upon which a user may query, and may return a listing of web resources associated with the keywords. Many such search engines are known in the art, with examples including, but not limited to, Google®, Yahoo® and Alta Vista®.

A search engine generally includes two main parts: an index searcher and an index generator. An index searcher may include a database of indexing keywords of web pages and logic for searching the database. An index generator may include a “spider” for gathering web pages and an “indexer” for generating an index into those pages. Typically, a search engine works by sending out the spider to fetch web pages (by, for example, following the various links that exist on an initial set of web pages). The indexer may then read these pages and create an index based on the words contained in each page. Search engines typically use a proprietary algorithm to create their indices such that, ideally, only meaningful results are returned for each query.

Provided with a page by a spider, an indexer may parse the document and insert selected keywords into the database with references back to the original location of the source page. How this is accomplished depends on the indexer. Some indexers index the titles of the web pages or just the first few paragraphs. Some parse the entire contents and index all words. Some parse available meta-tags or other special hidden tags. Meta-tags are special HTML tags that are meant to provide information about a web page. Unlike normal HTML tags, meta-tags do not affect how the page is displayed. Instead, they provide information such as who created the page, how often it is updated, what the page is about, and which keywords represent the page's content. Many search engines use this information when building their indices.

A common problem for these search engines is that they are, by necessity, automated. As such, the vagaries of human language may result in search results that are not always relevant to the query. For example, searching upon the keywords of “Miami” and “dolphins” may return web resources relevant to both a professional football team based in Florida, as well as aquatic mammals on display within the Miami locale. Further, automated search engines generally are poorly constructed to translate the context of web resources into a form searchable by keywords. For example, if searching for information regarding a consumer product, you likely are to receive web resources related to an individual consumer's experience with the product in addition to web resources which enable one to purchase the product. Finally, the relevance of any given web resource returned in response to a search engine query may be based upon a multitude of different factors, such as the number of web pages which refer to a given web resource, the number of times a given keyword appears within the text of a web resource, whether a person or corporation has paid the provider of the search engine to receive more favorable treatment, etc. Therefore significant effort may be required of the user in order to obtain relevant and preferred information via a search engine.

Furthermore, the Internet has voluminous resources and information sources available to it, yet the ability for an individual user to communicate or interact with a web resource generally is limited to that which the creator of the web resource allows. A user is limited in his ability to share or direct persons with whom he knows or shares a common interest; generally, he may either post a reference to the web resource on another web resource accessed by the persons he knows or accessed by those with whom he shares a common interest, or pass the URL to specific users or computers by direct communication, such as by electronic mail.

There have been various attempts to allow users to interact and comment on a web resource by means of an annotation system, such as, for example, US2004/0100498 by Dietz, et al, U.S. Pat. No. 6,826,595 by Barbash et al, and U.S. Pat. No. 6,551,357 by Madduri. Though allowing users to annotate or “mark-up” a web resource for later reference by the user, the prior art has not enabled users to fully benefit from the connectivity inherent with the Internet. Though the Internet allows access to resources and information, the ability to search for relevant and pertinent web resources and information has its limitations, as discussed above, as well as having limited ability to share network resources or information with others.

The present art has suffered from a limited ability using automated means to obtain contextual or semantic information from network resources, such as web pages within the Internet.

The accompanying description illustrates embodiments of the present invention and serves to explain the principles of the present invention.

### BRIEF DESCRIPTION OF THE FIGURES

FIG. 1 shows a schematic of the communications flow for a user computer running annotation client software, an annotation server and a network resource (for example, a web page) wherein the user computer is accessing a network resource via a network.

FIG. 2 shows an alternative means of delivering annotation software to the user computer.

FIG. 3 shows an example of an annotation associated with a network resource.

FIG. 4 shows a schematic of the communications flow between the network resource (Page) the user annotation client software (client) and the annotation server upon accessing a network resource.

FIG. 5 shows a schematic of the communications flow for increasing the relevance of search results using network resource annotation information.

FIG. 6 shows further details by way of a schematic of the communications flow for increasing the relevance of search results using network resource annotation information.

FIG. 7 shows further details by way of a schematic of the communications flow for increasing the relevance of search results using network resource annotation information.

### DETAILED DESCRIPTION

Embodiments of the present invention provide methods and systems for annotation of network resources existing within an electronic network. Further provided for are methods and systems for increasing, or decreasing the relevance of network resources comprising the results of a search through use of annotations associated with the network resources.

Various search and retrieval techniques have been employed to make the search and retrieval process more deterministic or efficient. For example, in the field of web resource retrieval, a vocabulary for describing web resources, or documents, has been employed, typically according to characteristics of the language itself. Such a system may operate much like an index of a book. For example, a description language may be derived based upon the frequency of occurrence of various words in the language and the juxtaposition statistics of these words (i.e., which words tend to appear together) within the web resource or document. This description language may then used to group various documents and to later retrieve them.

One fundamental search technique is the use of a keyword search that utilizes an index of keywords from an eligible listing. As another example, a network that maintains collections of documents may use an arbitrary set of words to characterize each document in the collection. When a user subsequently requests the retrieval of particular documents, the user may guess at what terms were used in the classification process, or instead may be presented with a fixed list, such as a list of categories. For example, a user might request the system to locate all documents having to do with “balloons”. The success of the search in this instance may be directly dependent on how many and which documents had been associated by the search system with the word “balloon”. Since the choice of the words used by the system to characterize the documents may be, and likely is arbitrary, the user's rate of success at picking the same words to describe the same document may be somewhat random.

Generally, the main problems with keyword searches are missing relevant documents or retrieving irrelevant documents, referred to as errors arising from “semantic mistyping”. Since words can be used in variant senses, a document can satisfy a query perfectly well when using a keyword-matching method, but the words in the keyword listing (or even within the network resource itself) may be used in a different sense than those used in the search query from which the search results are generated. Thus, semantic mistyping may lead to a poor user experience by decreasing the availability of relevant documents. Further, since words in languages may have multiple meanings, the possibility of erroneous search results is not insignificant.

A common method to mitigate errors attributable to semantic mistyping is to increase the relative ranking of network resources which are more “popular,” with popularity determined through, for example, the frequency of a network resource being selected by a user in prior search results, the frequency of a network resource being selected by the search engine to be included in the search results, the number of references to the network resource present within a network (i.e., number of network resources linking to the particular network resource), etc. In the case where two network resources are otherwise equal with regard to their appropriateness as a search result, the one with the higher rank may appear before (or instead of, etc.) the one with the lower rank.

Increasing the rank of a network resource within a list of search results based upon the popularity of the network resource does not necessarily correlate with increasing the relevance of the network resource, and such behavior has aspects of a self-reinforcing system. For example, the presence of an irrelevant network resource within a list of search results may result in a user accessing the irrelevant network resource for a period of time sufficient for the user to realize that it is not relevant. The user may then select another network resource within the list of search results, and on this second attempt the network resource may be relevant. In such a situation, the search system has difficulty in identifying that the first network resource was not relevant, while the second was: both received a “click-through” and therefore may be considered equally relevant by the search engine. As such, many of the search systems present in the art have difficulty identifying the relevance of network resources, this difficulty arising partially from the inherent vagaries of human language and the inherent weaknesses of search methodologies (such as keyword-based searches).

The present invention contemplates providing a system with which users may annotate documents within a network and where the users may share annotations with other users of the network or maintain their comments for their own reference, thereby providing certain contextual and relevancy information with respect to the pages being annotated. Network resources receiving a large number of annotations by a multiplicity of users may be considered to contain information more relevant than other network resources with less activity. Alternatively, the presence of certain keywords within the annotation may be used to derive the context of the underlying network resource to which the annotations are attached. Therefore the annotations made by users may collectively be utilized to increase the relevance of a resource present within a network when determining search results for a query. It is contemplated that the present invention may be equally applicable to networks containing various documents or resources, including but not limited to an intranet, or the Internet containing web resources.

By way of non-limiting example, the inclusion of specific keywords (e.g., “excellent”, “good”, “great”, “bought,” etc.) in an annotation on a network resource (such as a web page) intended for on-line shopping, may be used to increase the relevance of the particular web page to which the annotation is associated. The present invention is not limited to a single means of searching, or indexing of network resources, as the relevance of network resources, in accordance with the present invention, need only be compared to other network resources which would be identified by a similar search or indexing method. Therefore, the utility of screening the content of annotations made on network resources by users of the system of the present invention is applicable regardless of the underlying search system upon which the annotations add additional information.

One skilled in the art will recognize that the content of the annotations made by users, with respect to network resources, adds additional information which may be utilized to obtain information with respect to the relevance of the underlying network resource, the context of the underlying network resource, or other semantic information. In addition, simply the fact that an annotation has been made in association with a specific network resource may provide relevant and useful information with respect to the underlying network resource, especially relative to other network resources that have received no annotations. In one embodiment of the present invention, the number of annotations made with respect to a network resource may be utilized to increase the relevance of a given network resource among multiple search results.

In an alternate embodiment, the frequency of annotations may be utilized to increase the relevance of a given network resource among multiple search results. The frequency of annotations may be used to express the number of annotations of a network resource over a given period of time, the number of users making annotations relative to the total number of annotating users, the number of annotations made within a period of time relative to the total number of annotations made within the same period of time), etc.

In an alternative embodiment, any combination of the number or frequency of annotations may be utilized to increase the relevance of a given network resource.

Though the present invention is not limited to implementation with a particular annotation system, it is contemplated that, in one embodiment, the annotation system will maintain the annotations of users separate from the user computer, with at least one computer acting as a centralized server. The central server may receive a query from a client program executed on a user computer, wherein the query may contain, at a minimum, the URL of the network resource being viewed on the user computer. The central server may then respond to the query as to whether there exist annotations associated with the URL of the network resource. In an embodiment, the query also may contain a unique ID for the applicable user or user computer which may be used by the central server to determine which, if any, annotations the user or user computer is entitled to view (e.g., perhaps a group has been setup such that no one outside the group is allowed to view annotations made by group members, etc.). The benefits of this particular structure, in particular with the method and system for increasing relevance of search results within a network, is the ability to collate, collect, or scan annotation information from a multiplicity of users on at least one computer acting as a centralized server.

It is contemplated that the present method and system for increasing relevance of search results within a network may be implemented with annotation systems known in the art, for example those annotation systems based upon storage of annotation information for network resources in a distributed manner, such as, for example, when the annotation information for network resources for a given user is maintained within that user's computer or immediate computer network. In such a case, it may be necessary to query the distributed annotation systems for, at a minimum, the existence of annotations associated with a particular network resource (by use of, for example, a URL). Alternatively, the distributed annotation systems may be queried for just the existence of annotations, as well as the content of the annotations. In one embodiment based upon a distributed annotation system, the distributed systems may be queried on an intermittent basis, with the results collected and maintained at a central results server. Such a protocol may reduce query time upon receipt of search results (i.e., the time needed to determine whether any annotations exist for the search results), avoiding the requirement to query a multiplicity of distributed annotation systems each time search results are received.

In an embodiment the annotation system is based upon an annotation server in network communication with a user computer, whereby the annotation server supplies annotation information to a client software application running on the user's computer. As opposed to prior art implementations of annotation software for network resources, the underlying network resource (e.g., a web page) is not necessarily stored on the user computer or the annotation server. The system may store the annotations made by a user, optionally together with formatting information which may localize the annotations within the network resource, on an annotation server separate from the web server hosting the network resource. A user computer, through client software, may access the annotation server, wherein the annotation server may provide annotations to the client software. It will be appreciated that annotation localization may be implemented in any of a number of known ways, such as, for example, via x,y coordinates relative to the top-left pixel of a rendered web page. It also will be appreciated that some annotation types may not require localization, such as, for example, a “sticky” note not tied to any particular location on the network resource, a complementary annotation (as detailed below), etc.

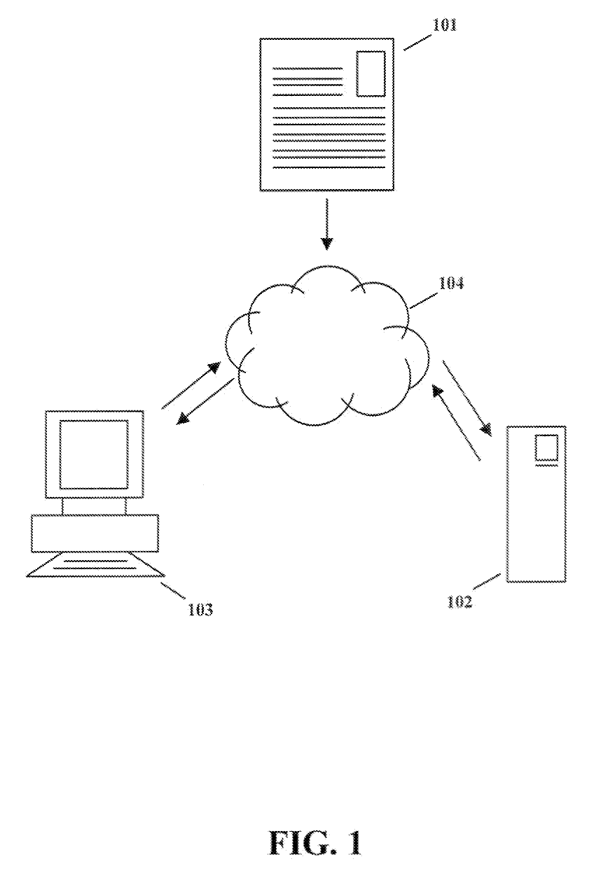

FIG. 1 shows a schematic of the relationship between user computer 103 containing annotation client software, and annotation server 102, wherein an annotation is made to a network resource 101 (e.g., a web page). It is explicitly contemplated that the annotations may be made on a variety of network resources, including but not limited to application specific documents, video content, audio content or databases. The communication between user computer 101, annotation server 102 and network resource 101 may be through a network 104 (e.g., the Internet).

The role of the annotation server within an annotation system is highly variable. Prior art systems have had communication with the network resource occur only through the annotation server, or alternatively have had the annotation server coordinating access of a plurality of users to annotations made with respect to a network resource, with annotation information stored within the user computer. In the annotation system contemplated by the present invention, the annotation server 102 communicates with user computer 103 through a client program within user computer 103, where the client program is in network communication with annotation server 102. In an embodiment, annotations may be stored by and communicated to user computer 103, and the annotations may be displayed in association with the network resource being accessed on user computer 103 by means of the client software. Alternatively, the annotations may be stored separately from annotation server 102 and/or user computer 103, and communicated through annotation server 102 to user computer 103 before the annotations are imposed upon the network resource being accessed on user computer 103 by means of the client software.

It is contemplated that the annotation client software may be resident on the user computer, operating either in conjunction with a program or in an environment within a program capable of accessing and displaying network resources and interpreting and effecting computer-readable instructions, including, but not limited to instructions written in Java®, JavaScript, languages particular to a certain web browser, etc. Installation of the annotation client software may be by a user such that the software is normally resident upon the computer and is available to the user upon each use of the software capable of accessing or browsing network resources (e.g., a web browser).

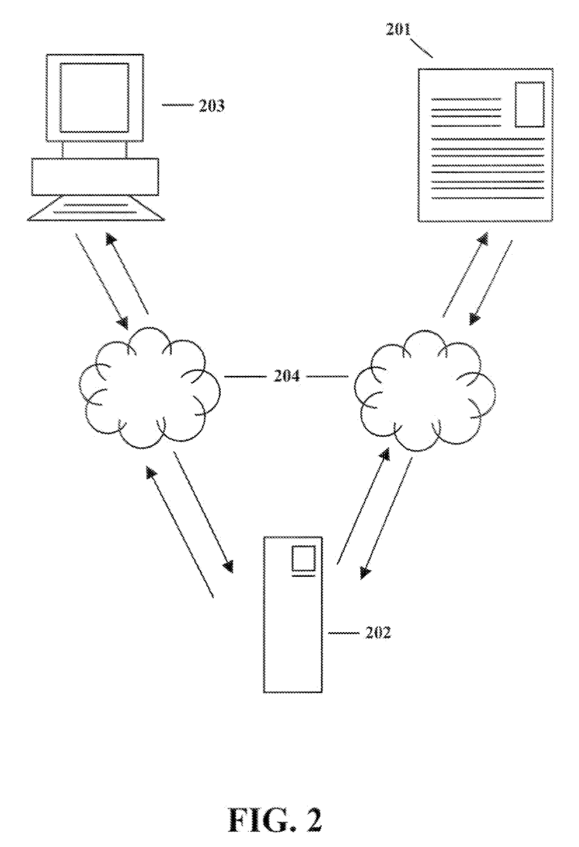

Alternatively, the annotation software may be delivered by means of a network proxy, as depicted in FIG. 2. In this instance, the annotation client software may run within the network browser environment (e.g., via JavaScript), and may be loaded on a per-page basis using a proxy server. In this embodiment, user computer 203 may seek access to network resource 201, wherein the access to network resource 201 may be routed through proxy server 202, with proxy server 202 accessing network resource 201. User computer 203, network resource 201 and proxy server 202 all may be in network communication through means of a common network 204 (e.g., the Internet). Network resource 201 may be obtained by proxy server 202 and passed on to user computer 203, together with computer software code capable of interpretation and operation within the user computer 203. The software code may be able to implement the processes and functions described and contemplated as the present invention, specifically the annotation reading and overlay code.

Generally, proxy server 202 only appends the annotation reading and overlay code prior to, or following, transmission of the originally requested network resource 201. The annotation reading and overlay code then may be interpreted within the program operating on user computer 203 that is responsible for the accessing and display of network resource 201.

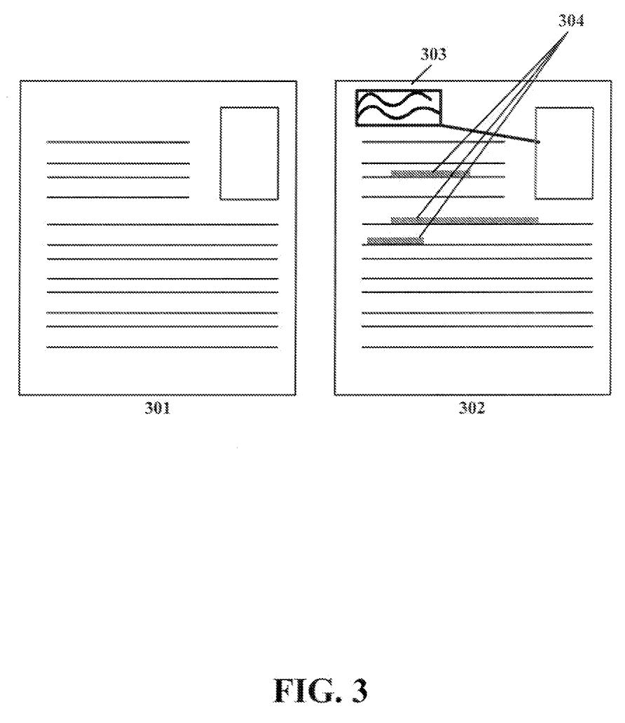

FIG. 3 illustrates non-limiting examples of annotations that may be made to an underlying network resource 301 (e.g., a web page), and the network resource with the annotations imposed upon it, 302. The annotations may include, for example, audio media, video media, addition of graphic images, the addition of text box 303 which may be anchored to a specific region of network resource 301/302, highlighting of specific text within the network resource, 304, etc.

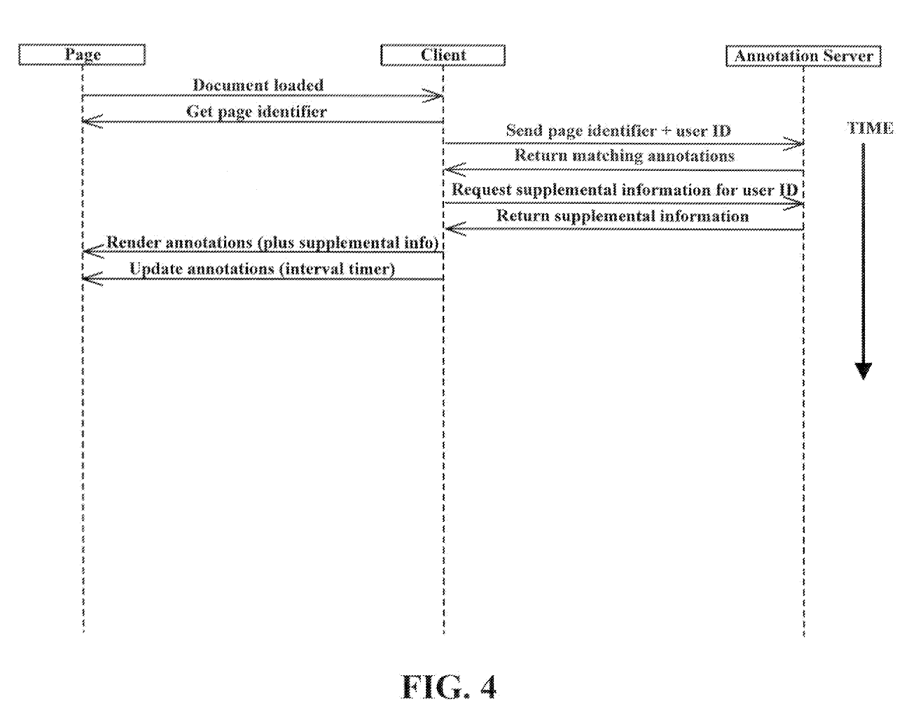

FIG. 4 illustrates an embodiment of the communication process by which the client software present on the user computer (“Client”) may obtain relevant annotations from the annotation server. Each network resource may carry with it a unique page identifier, for example a URL, which may be used for cataloguing annotations associated with the network resource. As the network resource is accessed on the user computer, client software (client) may communicate the page identifier to the annotation server, optionally together with a unique identifier code for the user computer, or alternatively for the client software (user ID). The annotation server may then use a series of processes to identify whether new annotations, not presently stored by the client software, are available for the particular page identifier and optionally whether those annotations are accessible by the particular user ID, and then may communicate those annotations to the client. The annotation may identify whether there are new annotations not presently stored by the client software by, for example, maintaining a record of what annotations have previously been sent to the client, or receiving from the client a list of annotations (or unique IDs associated with each of the annotations) that currently are stored by the client and comparing the list to the annotations currently available. In an embodiment, the annotation server may make no such determination, and may instead simply send to the client all annotations currently available for the particular network resource. It is contemplated that the annotations stored by the client software may be stored on the user computer on which the client software is operating, or alternatively on computer-readable memory physically separated from the user computer but in network communication therewith.

The annotation server also may determine whether the underlying network resource has significantly changed so as to render certain annotations irrelevant or useless, and if so, may not communicate those now-irrelevant annotations to the client. For example, the annotation server may calculate and keep track of a hash, checksum, etc. associated with the network resource (based on, for example, the HTML tags comprising a web page), and determine that the network resource has changed when the checksum changes, in which case it may send no or only a select few annotations to the client. Similarly, it may be determined on a per-annotation basis that the content that the annotation purports to describe has been modified, in which case the annotation may not be sent to or rendered at the client. For example, if the annotation server has an annotation highlighting a particular sentence within a particular network resource, but realizes, upon analyzing the network resource, that the sentence has changed or no longer exists, then the highlight may not be communicated to the client. As another example, consider a situation where an annotated image has been modified (e.g., different size, different name, etc.); in this case the image annotation may not be communicated to the client.

Optionally, various other potentially relevant information (“supplemental information”) may be communicated by the annotation server to the client. Supplemental information may include, but is not limited to, general information thought to be of relevance to the particular network resource being viewed, an annotation associated with the network resource, or a given user ID. In one embodiment supplemental information may be an advertisement expected to be relevant to the user. In an alternative embodiment, supplemental information may be a link to an alternative network resource. Once matching annotations and optionally supplemental information have been received by the client, the annotations (and optionally the supplemental information) may be rendered together with the network resource for the user to view.

In an embodiment, the client may poll the annotation server for new annotations or supplemental information, and the polling may occur in the background without any user interaction. For example, if the user is reading a long, popular article, it may be the case that annotations for the article arrive while he is reading the article; by polling the annotation server at a predetermined interval, the newer annotations may be presented to the user while he still is reading the article and may mitigate the chance that the user will never see the newer annotations.

In an embodiment, the annotations may be filtered based on various criteria. For example, the user ID of the user that created the annotation currently being viewed may be used to filter annotations by, for example, showing the user only annotations created by the user of the annotation currently being viewed. Similarly, the social graph of the user currently viewing the network resource may be used to filter the available annotations. For example, the user may filter the annotations by desiring to see only those annotations that were created by those who are associated with him on a particular social-networking service.

In an embodiment, the annotation server may, with or without explicit interaction from the user, find and send to the client other annotations (complementary annotations) that are not explicitly associated with the particular network resource being viewed, but are related in some way to the network resource, the user or user computer, etc. (complementary information) For example, if the user computer has requested annotations associated with a particular network resource—e.g., examplesite.com/page1—the annotation server may return annotations that are associated with other network resources within the same examplesite.com domain (e.g., examplesite.com/page2). Further, the complementary annotations may be based on, for example, the content of examplesite.com/page1. For example, if the user is reading about used cars at examplesite.com/page1, then the complementary annotations from examplesite.com (or other network resources not associated with examplesite.com) may include only those that appear to be related to used cars. Further still, and similar to the filtering discussed above, the complementary annotations may be based on the user ID of the user who created an annotation previously viewed at the user computer.

### Use of Annotations to Supplement Search Results

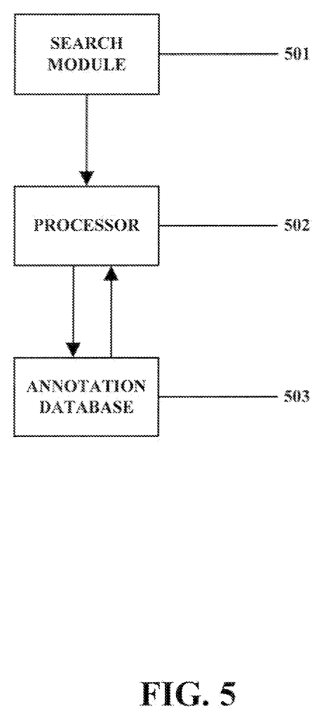

As shown in FIG. 5, it is contemplated that a processor module 502 integrate data obtained from search results received from a search module 501. It further is contemplated that an annotation database module 503 provide annotation information to processor module 502 with the purpose of enabling processor module 502 to modify the search results received so as to increase or decrease the relevance of a network resource within the search results. It is contemplated that search module 501 can be implemented either as a search engine accessible primarily by users of an annotation system, or alternatively may be a search engine otherwise available to the public, for example including but not limited to Google® or Yahoo®. In one embodiment, the search engine may be any search engine preferred or desired by a user, with the search results generated by said search engine (i.e., search module 501) directed into processor module 502 for relevance sorting using data obtained from annotation database module 503. Following relevance sorting, the search results, optionally re-ordered due to the increase or decrease of relevance of particular network resources contained within the search results, may be displayed to the user. In one embodiment, the user may choose between viewing the search results in their original order as obtained from search module 501, or the potentially modified search results arising from processing using the annotation database.

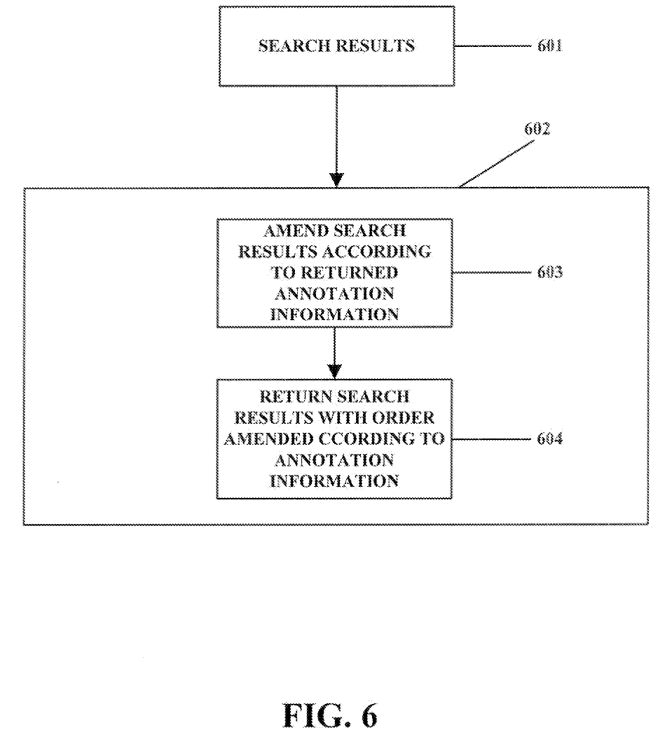

FIG. 6 shows a summary of a process that may be used within the processor module 502, as depicted in FIG. 5. Search results 601, corresponding to module 501 depicted in FIG. 5, may be imported into processor module 602, corresponding to module 502 depicted in FIG. 5. Sub-module 603 may amend the order of the search results according to information obtained from the annotation database, which information may either increase or decrease the relevance of a network resource (and therefore, perhaps, the position within the ordered list of search results 601). Sub-module 804 may then return the amended search results to the user.

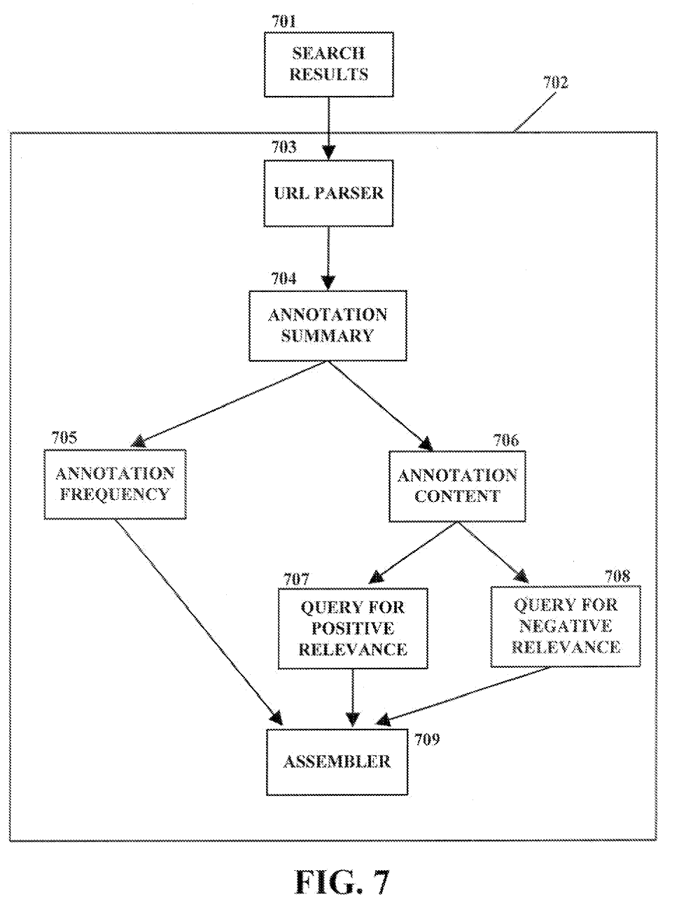

FIG. 7 shows further detail of the processing module 702, which previously was depicted as 502 in FIG. 5 and as 602 in FIG. 6. Search results 701 may be received into processing module 702 where they may be processed by sub-module 703, where the URL for each network resource forming the search results is reduced to a basic structure and compared to an annotation database to determine if annotations exist within the database for any of the URLs. By reducing a URL to a basic structure, it is contemplated that the URL is stripped of superfluous information not relevant or otherwise present in the annotation database. As an example of reducing a URL to its basic structure consider the following URLs: 1) examplesite.com/page1?cust=4, 2) examplesite.com/page1#anchor2 and 3) examplesite.com/page1#anchor2. In this example, the basic structure of the URL may be examplesite.com/page1.

In one embodiment, the annotation database may contain annotations made by multiple or all of the users of the annotation system, which annotations may each be paired to a unique identifier for the network resource upon which the annotation was made. In an alternate embodiment, the annotation database may be limited to a subset of annotations, such as, for example, annotations made by a particular user, group of users of similar demographics, group of users of similar geographic location, group of users of similar language, group of users of similar nationality, group of users of similar employer, etc. It is contemplated that any unique identifier for network resources may be used, and a functional equivalent of the URL parser used for each type of unique identifier of network resources.

Once the URLs have been reduced into a basic structure and compared to the annotation database, the annotations, if any, for the URLs within the search results may be assembled and summarized (704). One skilled in the art will recognize that the summary process may take many forms, with the goal to be able to assess whether an annotation associated with a URL within the search results increases, or decreases, the relevance of that URL within the search results, which may in turn cause the network resource associated with that URL to be placed nearer to the top of the list of search results.

In one embodiment, the presence of an annotation, or annotations, within the annotation database associated with a given URL may indicate that a URL has increased relevance (“annotation frequency”). Further, URLs with more annotations associated with them may be deemed more relevant than URLs with fewer annotations.

In an alternative embodiment, the content of annotations associated with URLs may be used to determine if there exist certain types of annotations or terms within an annotation that may be associated with increased relevance of a particular URL (“positive relevance”). For example, highlights on a network resource may indicate what on the network resource is most relevant to the user, and if, for example, the highlighted information corresponds to the search query that initially caused the network resource to be found, then the network resource's relevance among the search results may be increased. As another example, consider an annotation comprising a comment made by a user that is particularly effusive—e.g., “This is the best site I've found on topic X”—and the search query that initially caused the network resource to be found was, for example, “information on topic X.” In this case, the annotation may be used to increase the network resource's relevance among the search results. It will be appreciated that such contextual analysis need not require that the annotation necessarily correspond to the search query in order to increase the network resource's relevance.

In an alternative embodiment, the content of annotations associated with URLs may be used to determine if there exist certain types of annotations or terms within an annotation that may be associated with decreased relevance of a particular URL (“negative relevance”). For example, consider an annotation comprising a comment made by a user that is particularly negative—e.g., “This is the worst site I've found on topic X”—and the search query that initially caused the network resource to be found was, for example, “information on topic X.” In this case, the annotation may be used to decrease the network resource's relevance among the search results.

Also, certain types of annotations may be given weight over other types of annotations. For example, if the relevance of two network resources are otherwise equal, and each has a single annotation associated with it, the network resource whose annotation is a highlight may be deemed more relevant than the network resource whose only annotation is a comment.

In one embodiment, annotation frequency and the presence of positive/negative relevance data within annotations may together be used to increase or decrease the relevance of a particular network resource as among multiple search results. As shown in FIG. 9, sub-module 705 may assess the annotation frequency, while sub-modules 707 and 708 may determine the presence of positive relevance data and negative relevance data, respectively, where both 707 and 708 may be under the control of sub-module 706. The output of sub-modules 705, 707and 708 may be received by assembler sub-module 709, which may weigh the outputs, and accordingly may increase or decrease the relevance of a given network resource within the list of search results. Assembler sub-module 709 may then provide to the user the list of search results, optionally reordered according to the relevance information.

It is contemplated by the present invention that the ordering within an ordered list of search results may be altered in order to place network resources with higher relevance closer to the top of the list. As well, it is contemplated that the ordered list may be kept in its original state, and a relevance “score” or weighting value applied to each network resource within the ordered list of search results. The weighting value or score may be displayed in association with the ordered list of search results, or alternatively may be displayed in a graphical fashion by, for example, color-coding, bolding, using a different font, etc.

The various systems, modules, etc. described herein may each include a storage component for storing machine-readable instructions for performing the various processes as described and illustrated. The storage component may be any type of machine-readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer-readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

Although the preceding text sets forth a detailed description of various embodiments, it should be understood that the legal scope of the invention is defined by the words of the claims set forth below. The detailed description is to be construed as exemplary only and does not describe every possible embodiment of the invention since describing every possible embodiment would be impractical, if not impossible. Numerous alternative embodiments could be implemented, using either current technology or technology developed after the filing date of this patent, which would still fall within the scope of the claims defining the invention.

1. A computer-implemented method for supplementing a search for specific network resources within a communication network, said method comprising:
receiving, at a server, an ordered list of network resources, wherein the network resources are ordered according to their relevance to a search query;
responsive to at least one annotation associated with at least one network resource within the ordered list, modifying, at the server, the relevance of the at least one network resource relative to the other network resources within the ordered list; and
sending, from the server, the ordered list of network resources together with an indication of said relevance modification to a user computer.

2. The method of claim 1 wherein the at least one annotation contains at least one element selected from the group consisting of:
a location of the at least one annotation within the at least one network resource;
a description of the content of the at least one network resource;
an indicator of the context of the at least one network resource; and
an indicator of the type of the at least one annotation.

3. The method of claim 1 wherein said modifying is further responsive to a frequency with which annotations are associated with the at least one network resource.

4. The method of claim 1 wherein the at least one annotation is of an annotation type selected from the group consisting of:
a comment;
a highlight;
an image;
audio media; and
video media.

5. The method of claim 1 wherein the indication of said relevance modification is a re-ordered list of network resources, wherein the list is re-ordered according to the modified relevance of the at least network resource.

6. The method of claim 1 wherein the indication of said relevance modification is a relevance score displayed substantially concomitantly with the at least one network resource.

7. The method of claim 6 wherein the relevance score is indicated by at least one element selected from the group consisting of:
coloring the at least one network resource different from the other network resources within the ordered list;
bolding the at least one network resource; and
displaying the at least one network resource in a font that is different from a font used for the other network resources within the ordered list.

8. The method of claim 1 further comprising:
responsive to the search query, generating the ordered list of network resources.

9. The method of claim 1 further comprising, prior to said modifying, searching for annotations associated with any of the network resources within the ordered list, wherein each network resource is identified by a resource identifier.

10. The method of claim 9 wherein the resource identifier is a Universal Resource Locator (URL).

11. The method of claim 1 wherein said modifying is further responsive to the number of annotations associated with the at least one network resource.

12. A computer-implemented method for maintaining and making available to users annotations associated with a network resource, said method comprising:
receiving, over a communication network from a first user computer, an annotation associated with a first network resource, wherein the first network resource is identified by a first resource identifier;
storing the annotation in an annotation database, wherein the annotation is associated with the network resource via the resource identifier;
receiving, over the communication network from a second user computer, an annotation query, wherein the annotation query comprises a second resource identifier;
responsive to the annotation query, retrieving from the annotation database at least one annotation associated with the second resource identifier; and
sending, over the communication network to the second user computer, the retrieved annotation, wherein the retrieved annotation is displayed substantially concomitantly with the network resource associated with the second resource identifier.

13. The method of claim 12 wherein the annotation query further comprises information identifying the second user computer, and wherein the information identifying the second user computer determines whether the retrieved annotation will be sent to the second user computer.

14. The method of claim 12 further comprising sending supplemental information to the second user computer, wherein the supplemental information is displayed substantially concomitantly with the network resource associated with the second network resource identifier.

15. The method of claim 14 wherein the supplemental information is potentially relevant to at least one element selected from the group consisting of:
the network resource associated with the second resource identifier;
the retrieved annotation; and
a user associated with the second user computer.

16. The method of claim 12 further comprising sending computer-executable instructions that the user computer executes to display the retrieved annotation.

17. The method of claim 16 wherein the computer-executable instructions comprise JavaScript.

18. The method of claim 12 further comprising filtering the retrieved annotation based on filter criteria, wherein the filter criteria is selected from the group consisting of:
an author of an annotation previously viewed at the second user computer; and
a group with which a user of the second user computer is associated.

19. The method of claim 12 further comprising:
responsive to complementary information, retrieving from the annotation database at least one complementary annotation, wherein the complementary annotation is associated with a third resource identifier; and
sending, over the communication network to the second user computer, the retrieved complementary annotation.

20. The method of claim 19 wherein the complementary information is at least one element selected from the group consisting of:
a domain associated with the second resource identifier, wherein the second resource identifier is a URL;
an author of an annotation previously viewed at the second user computer; and
content associated with a network resource identified by the second resource identifier.

21. A system for supplementing a search for specific network resources within a communication network, said system comprising:
a search results module within a server to receive an ordered list of network resources that were generated in response to a search query;
an annotation database to store annotations associated with a plurality of network resources, wherein each network resource is identified by a resource identifier;
an annotation summary module within the server to:
retrieve annotations from the annotation database that are associated with the network resources within the ordered list; and
analyze the annotations;
an assembler module within the server to modify the relevance of the network resources within the ordered list according to information derived from the annotation summary module.

22. The system of claim 21 wherein the annotation summary module comprises an annotation frequency sub-module to determine a frequency with which annotations are applied to each of the network resources within the ordered list.

23. The system of claim 21 wherein the annotation summary module comprises an annotation content sub-module to determine how the content of an annotation associated with a particular network resource within the ordered list will affect the relevance of the particular network resource.

24. The system of claim 21 further comprising a search module to receive a search query and generate the ordered list of network resources in response thereto.

25. A system for maintaining and making available to users annotations associated with network resources, said system comprising:
an annotation database to store a plurality of annotations and a plurality of resource identifiers, wherein each of the annotations and resource identifiers is associated with one of a plurality of network resources; and
an annotation server to:
receive, from a first user computer, a first annotation associated with a first network resource, wherein the first network resource is associated with a first resource identifier;
save to the annotation database the first annotation and the first resource identifier;
receive an annotation query from a second user computer, wherein the annotation query comprises a second resource identifier;
responsive to the annotation query, retrieve from the annotation database at least one annotation associated with the second resource identifier; and
send to the second user computer the retrieved annotation, wherein the retrieved annotation is displayed substantially concomitantly with the network resource associated with the second resource identifier.

26. The system of claim 25 wherein the resource identifiers are Universal Resource Locators (URLs).

27. A computer-readable medium encoded with a set of instructions which, when performed by a computer, perform a method comprising:
receiving, at a server, an ordered list of network resources, wherein the network resources are ordered according to their relevance to a search query;
responsive to at least one annotation associated with at least one network resource within the ordered list, modifying, at the server, the relevance of the at least one network resource relative to the other network resources within the ordered list; and
sending, from the server, the ordered list of network resources together with an indication of said relevance modification to a user computer.

28. The computer-readable medium of claim 27 wherein the at least one annotation contains at least one element selected from the group consisting of:
a location of the at least one annotation within the at least one network resource;
a description of the content of the at least one network resource;
an indicator of the context of the at least one network resource; and
an indicator of the type of the at least one annotation.

29. The computer-readable medium of claim 27 wherein said modifying is further responsive to a frequency with which annotations are associated with the at least one network resource.

30. The computer-readable medium of claim 27 wherein the indication of said relevance modification is a re-ordered list of network resources, wherein the list is re-ordered according to the modified relevance of the at least network resource.

31. The computer-readable medium of claim 27 wherein said modifying is further responsive to the number of annotations associated with the at least one network resource.

32. A computer-readable medium encoded with a set of instructions which, when performed by a computer, perform a method comprising:
receiving, over a communication network from a first user computer, an annotation associated with a first network resource, wherein the first network resource is identified by a first resource identifier;
storing the annotation in an annotation database, wherein the annotation is associated with the network resource via the resource identifier;
receiving, over the communication network from a second user computer, an annotation query, wherein the annotation query comprises a second resource identifier;
responsive to the annotation query, retrieving from the annotation database at least one annotation associated with the second resource identifier; and
sending, over the communication network to the second user computer, the retrieved annotation, wherein the retrieved annotation is displayed substantially concomitantly with the network resource associated with the second resource identifier.

33. The computer-readable medium of claim 32 wherein the annotation query further comprises information identifying the second user computer, and wherein the information identifying the second user computer determines whether the retrieved annotation will be sent to the second user computer.

34. The computer-readable medium of claim 32 wherein the method further comprises sending supplemental information to the second user computer, and wherein the supplemental information is displayed substantially concomitantly with the network resource associated with the second network resource identifier.
